(19) United States
(12) Patent Application Publication
(10) Pub. No.: US 2026/0366327 A1
(43) Pub. Date: Nov. 19, 2026

(54) LOCK HANDLE CONNECTION STRUCTURE

(71) Applicant: TAIWAN FU HSING INDUSTRIAL CO., LTD., Kaohsiung City (TW)

(72) Inventors: Tien-Fu Chan, Kaohsiung City (TW); Chi-Ming Chen, Kaohsiung City (TW)

(73) Assignee: TAIWAN FU HSING INDUSTRIAL CO., LTD., Kaohsiung City (TW)

(21) Appl. No.: 19/550,278

(22) Filed: Feb. 26, 2026

(30) Foreign Application Priority Data
May 13, 2025 (TW) 114117796

(51) Int. Cl. E05B 3/00; E05B 15/00; E05B 63/00

(52) U.S. Cl. CPC E05B 3/003; E05B 15/0033; E05B 63/0056

(57) ABSTRACT

A lock handle connection structure includes a mounting plate, a rotating shaft, a handle, and an enhancement part. The mounting plate has a shaft hole. The shaft hole has a hole axis. The rotating shaft is rotatably connected to the shaft hole relative to the hole axis. The handle includes a sleeve portion. The sleeve portion is sleeved on and connected to the rotating shaft, so that the handle and the rotating shaft rotate together. The enhancement part is disposed on an outer side or an inner side of the sleeve portion to keep the sleeve portion sleeved on the rotating shaft.

### BACKGROUND OF THE INVENTION

### 1. Field of the Invention

The present invention relates to a lock, and more particularly to a lock handle connection structure.

### 2. Description of the Related Art

The flat handle used in a common lock is connected to the rotating shaft of the lock through a tube structure so that the flat handle and the rotating shaft can rotate together. However, since the center of gravity of the flat handle is not on the center line of the rotating shaft, the flat handle is easily affected by gravity and droops after long-term use. Although reducing the weight of the flat handle helps to reduce the drooping problem, it will damage the structural strength of the flat handle, especially the strength of the connection structure between the flat handle and the rotating shaft. A connection structure with insufficient strength is prone to weakening or even failure after long-term use, seriously affecting the service life of the lock.

### SUMMARY OF THE INVENTION

In view of the problems in the prior art, an objective of the invention is to provide a lock handle connection structure, which uses an enhancement part to enhance the stability of the connection between a handle and a rotating shaft.

A lock handle connection structure of an embodiment according to the invention is used in a lock. The lock handle connection structure includes a mounting plate, a rotating shaft, a handle, and an enhancement part. The mounting plate has a shaft hole. The shaft hole has a hole axis. The rotating shaft is rotatably connected to the shaft hole relative to the hole axis. The handle includes a sleeve portion. The sleeve portion is sleeved on the rotating shaft, so that the handle and the rotating shaft rotate together. The enhancement part is disposed on an outer side or an inner side of the sleeve portion to keep the sleeve portion sleeved on the rotating shaft. For example, the enhancement part may be a ring, and the ring is fixedly disposed on the mounting plate and sleeved on the sleeve portion. Thereby, the ring can structurally constrain the sleeve portion, enhancing the stability of the connection between the sleeve portion and the rotating shaft For another example, the enhancement part may be a sleeve, the handle is combined with the sleeve by the sleeve portion sleeved on the sleeve, and the sleeve portion is sleeved on the rotating shaft through the sleeve. The structural strength of the sleeve is greater than that of the sleeve portion. Thereby, the sleeve portion is indirectly sleeved on the rotating shaft through the sleeve with greater structural strength, so the sleeve can also enhance the stability of the connection relationship between the sleeve portion and the rotating shaft.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a lock according to an embodiment.

FIG. 2 is a partially-exploded view of the lock in FIG. 1.

FIG. 3 is a partially-exploded view of an outer lock body in FIG. 2.

FIG. 4 is a schematic diagram of the outer lock body FIG. 3 from another viewpoint.

FIG. 5 is a diagram illustrating the combination of a rotating shaft, a ring, and a mounting plate in FIG. 4.

FIG. 6 is a diagram illustrating the combination of the rotating shaft, the mounting plate, and a handle in FIG. 4.

FIG. 7 is a schematic diagram illustrating a combination of a handle and a sleeve according to another embodiment.

FIG. 8 is an exploded view of the handle and the sleeve in FIG. 7.

### DETAILED DESCRIPTION

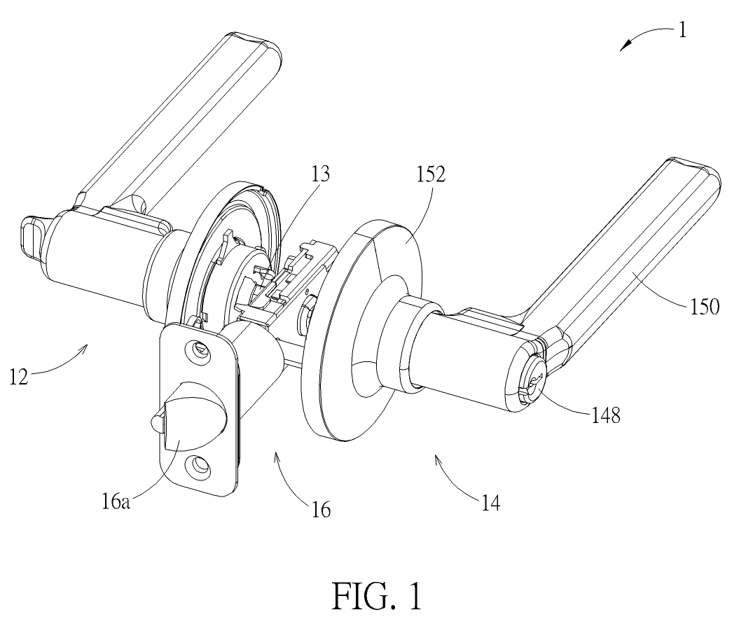

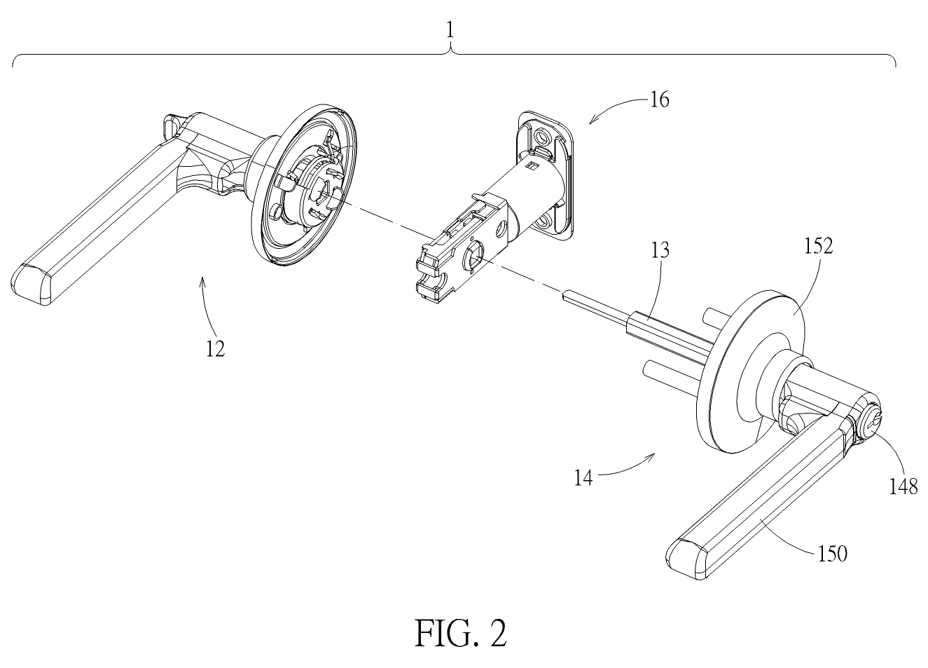

Please refer to FIGS. 1 and FIG. 2. A lock 1 according to an embodiment includes an inner lock body 12, an outer lock body 14, and a latch assembly 16. In practice, the lock 1 can be mounted on a door panel. Therein, the inner lock body 12 and the outer lock body 14 are disposed on both sides of the door panel and connected to each other, and the latch assembly 16 is disposed in a mounting hole of the door panel and a latch 16a of the latch assembly 16 protrudes from the edge side of the door panel. The inner lock body 12 and the outer lock body 14 are linked to the latch assembly 16 through a transmission rod 13 to drive the latch 16a; the linkage mechanism is equivalent to that of a common door lock, and is well known to those having ordinary knowledge in the relevant technical field, which will not be described in addition.

Please refer to FIGS. 2 - FIG. 6. In the embodiment, the outer lock body 14 includes a mounting plate 142, a rotating shaft 144, an enhancement part (e.g., a ring 146), a lock cylinder 148, a handle 150, a decorative cover 152, and other components (not labeled in the figures). The outer lock body 14 is fixed on the door panel through the mounting plate 142. The mounting plate 142 has a shaft hole 142a that has a hole axis 142b (indicated by a chain line in the figures). The rotating shaft 144 is rotatably connected to the shaft hole 142a relative to the hole axis 142b. The lock cylinder 148 is assembled to (an end portion of) the rotating shaft 144. The handle 150 is sleeved on the rotating shaft 144, so that the handle 150 and the rotating shaft 144 can rotate together around the hole axis 142b (relative to the mounting plate 142). The ring 146 is fixedly disposed on the mounting plate 142 and sleeved on the handle 150, so that the ring 146 structurally constrains the handle 150 (especially the portion of the handle 150 sandwiched between the rotating shaft 144 and the ring 146), thereby keeping the handle 150 sleeved on the rotating shaft 144, that is, enhancing the stability of the connection between the handle 150 and the rotating shaft 144. The decorative cover 152 is fixed to the mounting plate 142 (e.g., by snapping onto the outer edge of the mounting plate 142 through an engaging structure). The handle 150 protrudes from a through hole 152a of the decorative cover 152. The decorative cover 152 covers the entire ring 146. Therein, the lock handle connection structure of the outer lock body 14 may be defined as including the mounting plate 142, the rotating shaft 144, the ring 146, and the handle 150 (and the decorative cover 152).

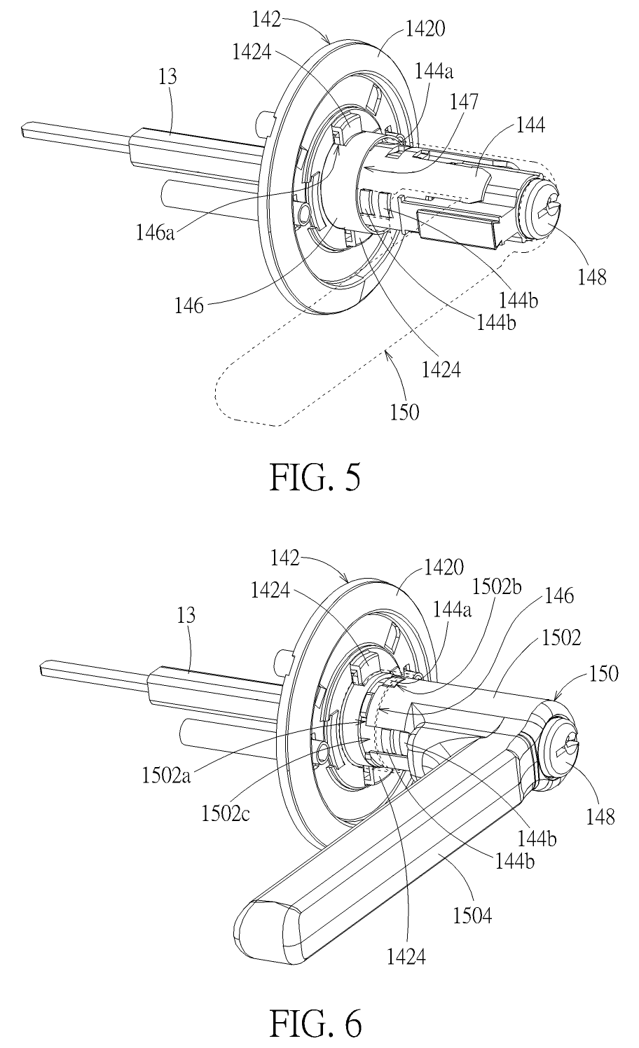

Further, the mounting plate 142 includes a plate body 1420, and a peripheral wall 1422 that is bent and extended from the plate body 1420 and surrounds the shaft hole 142a (in other words, the peripheral wall 1422 forms the shaft hole 142a). The rotating shaft 144 passes through the shaft hole 142a and abuts against the opening edge of the peripheral wall 1422. The peripheral wall 1422 provides rotation support for the rotating shaft 144. The ring 146 is sleeved on the peripheral wall 1422 (e.g., by tight fitting), so that an annular groove 147 is formed between the ring 146 and the rotating shaft 144 (as shown in FIG. 5). The handle 150 is inserted into the annular groove 147 (referring to FIGS. 5 and FIG. 6; therein, the outline of the handle 150 in FIG. 5 is shown in dotted lines, and the outline of the ring 146 in FIG. 6 is shown in dotted lines); on the other hand, the handle 150 (or the portion corresponding to the ring 146) is structurally constrained between the ring 146 and the rotating shaft 144, so the handle 150 cannot be deformed radially inward or outward. Furthermore, the mounting plate 142 includes two positioning blocks 1424 located on opposite sides of the peripheral wall 1422. The ring 146 has two positioning slots 146a correspondingly. The two positioning blocks 1424 fit in the two positioning slots 146a, respectively, to prevent the ring 146 from rotating relative to the mounting plate 142 around the hole axis 142b. In addition, in the embodiment, the ring 146 is directly fixed to the mounting plate 142; however, it is not limited thereto in practice. For example, the position of the ring 146 along the hole axis 142b relative to the mounting plate 142 is constrained by other structures, e.g., forming a protrusion at a proper position of the handle 150 to block the ring 146 to prevent it from moving along the hole axis 142b.

The handle 150 includes a sleeve portion 1502, and a grip lever portion 1504 connected to the sleeve portion 1502. The handle 150 is sleeved on the rotating shaft 144 through the sleeve portion 1502 (therein, the sleeve portion 1502 is sleeved on the rotating shaft 144 through an opening 1502a of the sleeve portion 1502). The grip lever portion 1504 extends non-parallel to the hole axis 142b; in other words, in the embodiment, the handle 150 as a whole is not a simple rod structure, but an L-shaped structure, so that the center of gravity of the handle 150 does not fall on the hole axis 142b. The ring 146 is sleeved on the sleeve portion 1502. Furthermore, the sleeve portion 1502 and the rotating shaft 144 can rotate together through an engaging structure. Therein, the rotating shaft 144 has two protrusions 144a located on opposite sides, and two protrusions 144b arranged axially. Correspondingly, the sleeve portion 1502 has two engagement slots 1502b located on opposite sides, and an open slot 1502c. The engagement slot 1502b and the open slot 1502c are both formed on the opening 1502a. The two protrusions 144a fit in the two engagement slots 1502b, respectively. The two protrusions 144b are inserted into the open slots 1502c. Through the mutual structural restraint between the engagement slot 1502b and the open slot 1502c and the protrusions 144a and 144b, the sleeve portion 1502 and the rotating shaft 144 rotate together.

In the embodiment, the engaging structure is implemented by an engagement slot (e.g., the engagement slot 1502b) and a protrusion (e.g., the protrusion 144a); however, it is not limited thereto in practice. For example, any structure that can make the sleeve portion 1502 rotate with the rotating shaft 144 is applicable. Moreover, in the embodiment, the engagement slot (e.g., the engagement slot 1502b) is formed on the sleeve portion 1502, and the protrusion (e.g., the protrusion 144a) is formed on the rotating shaft 144; however, it is not limited thereto in practice. For example, the engagement slot is changed to be formed on the rotating shaft 144 (e.g., by a groove or a through hole), and the protrusion is changed to be formed on the inner side of the sleeve portion 1502 (e.g., by the side wall of the sleeve portion 1502 protruding inwardly). During assembly, the open slot 1502c of the sleeve portion 1502 can be utilized to generate structural elasticity so that the protrusion can fit in the engagement slot. Furthermore, in practice, the numbers and locations of the engagement slot and the protrusion are not limited to those in this embodiment. For example, more or fewer engagement slots and protrusions are used. For another example, the sleeve portion 1502 has both an engagement slot and a protrusion, and the rotating shaft 144 also has a protrusion and an engagement slot correspondingly. In addition, in the structural configuration of the outer lock body 14, the open slot 1502c is an avoidance structure to avoid interference with the lock cylinder 148 during assembly. The open slot 1502c is engaged with the two protrusions 144b to enhance the structural strength of the connection between the sleeve portion 1502 and the rotating shaft 144. Furthermore, the mutual structural constraint between the open slot 1502c and the protrusion 144b also has the effect of making the sleeve portion 1502 and the rotating shaft 144 rotate together, so the open slot 1502c is logically regarded as an engagement slot. In the embodiment, the rotating shaft 144 and the handle 150 are mutually driven through the three protrusion/engagement slots (i.e., the protrusions 144a and 144b, the engagement slot 1502b, and the open slot 1502c). The three protrusion/engagement slots are not located on the same cross section (perpendicular to the hole axis 142b). This structural configuration helps to effectively disperse the transmission force between the handle 150 and the rotating shaft 144 to avoid hole expansion (i.e., to prevent the opening 1502a from being stretched).

Furthermore, as shown by FIGS. 5 and FIG. 6, the protrusion 144a and the engagement slot 1502b are both located inside the ring 146. This structural configuration can enhance the stability of the connection structure between the sleeve portion 1502 and the rotating shaft 144 by the ring 146. Moreover, in the embodiment, the ring 146 completely covers the protrusion 144a and the engagement slot 1502b, which can further enhance the stability of the connection structure; however, it is not limited thereto in practice. In principle, both the protrusion 144a and the engagement slot 1502b are at least partially located inside the ring 146, so that the ring 146 enhances the stability of the connection structure. In addition, the opening 1502a of the sleeve portion 1502 is located inside the ring 146 (i.e., the ring 146 completely covers the opening 1502a), and the ring 146 structure constrains the opening 1502a, so that when the sleeve portion 1502 rotates with the rotating shaft 144 (e.g., when the user rotates the handle 150), the shape of the opening 1502a can remain unchanged without being deformed. In particular, in a case that the thickness of the handle 150 is reduced in order to reduce the weight of the handle 150, it is generally easier to deform at the opening 1502a, but by constraining the opening 1502a through the ring 146, the shape of the opening 1502a can still remain unchanged without being deformed. In addition, as shown by FIGS. 1 and FIG. 2, the decorative cover 152 completely covers the mounting plate 142, the protrusion 144a, the engagement slot 1502b, and the ring 146 to enhance the aesthetics of the outer lock body 14.

As shown by FIGS. 1 and FIG. 2, in the embodiment, the structures of the handle and rotating shaft of the inner lock body 12 and the corresponding transmission structure are similar to those of the outer lock body 14 and are not described in addition. Similarly, for understanding the structure of the outer lock body 14, one may also refer to the corresponding structure of the inner lock body 12 in the figures. Moreover, this design with the same structure helps to reduce the manufacturing cost of the lock 1. In addition, the engagement slot 1502b is formed on the handle 150, which has the characteristics of being easy to process and easy to keep the appearance of the handle 150 flat.

In the embodiment, the handle 150 is a single structural part, and through the structural restraint of the ring 146, the handle 150 can be stably connected to the rotating shaft 144 without increasing the thickness of the handle 150 itself, so that the thickness of the handle 150 can be reduced in practice, effectively reducing the weight. However, it is not limited thereto to.

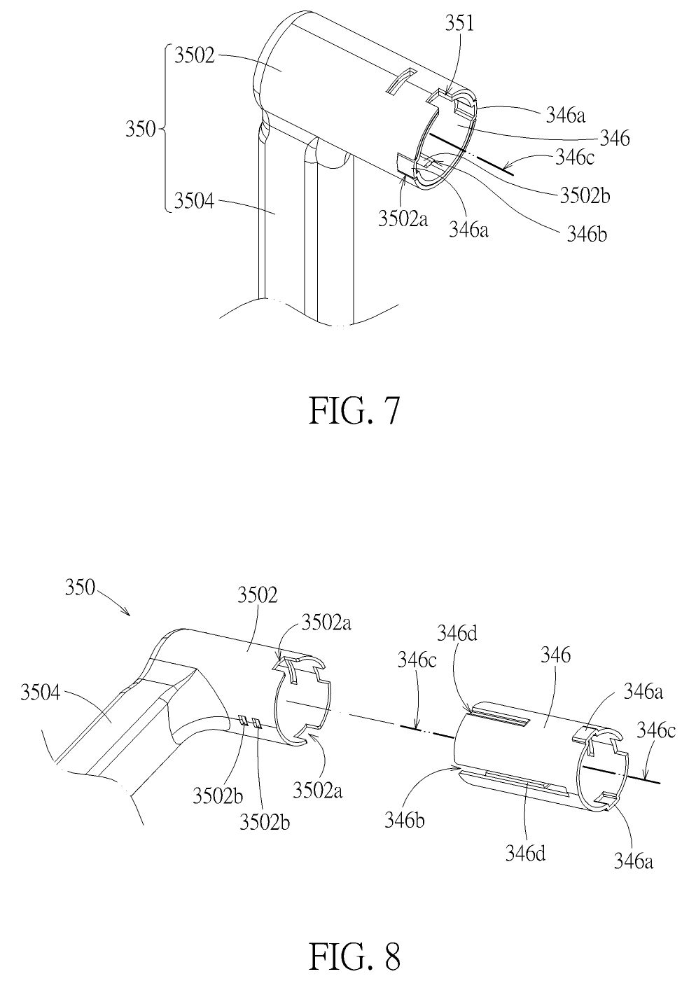

In addition, in the above embodiment, the enhancement part is implemented by the ring 146. The handle 150 is directly sleeved on the rotating shaft 144, and the sleeve portion 1502 is constrained by a ring 146 (disposed outside the sleeve portion 1502 of the handle 150) to enhance the stability of the connection structure between the sleeve portion 1502 and the rotating shaft 144, but it is not limited thereto in practice. The handle 150 is directly connected to the rotating shaft 144. The sleeve portion 1502 is constrained by the ring 146 (disposed on the outer side of the sleeve portion 1502 of the handle 150) to enhance the stability of the connection structure between the sleeve portion 1502 and the rotating shaft 144. However, it is not limited thereto in practice. For example, please refer to FIGS. 7 and FIG. 8, which are a schematic diagram and an exploded view of a combination of a handle 350 and an enhancement part (e.g., a sleeve 346) according to another embodiment. The handle 350 also includes a sleeve portion 3502 and a grip lever portion 3504 connected to the sleeve portion 3502. Similarly, the handle 150 as a whole is not a simple rod structure, but an L-shaped structure. The handle 350 is sleeved on the sleeve 346 through the sleeve portion 3502 to be combined with the sleeve 346. Therein, the sleeve portion 3502 is connected to the sleeve 346 through an engaging structure. The sleeve portion 3502 has two engagement slots 3502a located at opposite sides, and two protrusions 3502b arranged along the axial direction (protruding toward the inner side of the sleeve portion 3502). Correspondingly, the sleeve 346 has two protrusions 346a located at opposite sides, and an open slot 346b. The two protrusions 346a fit in the two engagement slots 3502a, and the two protrusions 3502b fit in the open slot 346b. Moreover, the sleeve portion 3502 and the sleeve 346 jointly form another engagement slot 351 (as shown in FIG. 7). The three protrusion/engagement slots (i.e., the protrusions 3502b and 346a, the open slot 346b, and the engagement slot 3502a) are not located on the same cross section (perpendicular to a hole axis 346c, indicated by a chain line in the figures and in principle coinciding with the hole axis 142b of the mounting plate 142). This structural configuration helps the sleeve portion 3502 and the sleeve 346 to be firmly combined. In addition, in practice, the engaging structure may also be implemented by any structure that can make the sleeve portion 3502 rotate together with the sleeve 346; furthermore, the combination of the sleeve portion 3502 and the sleeve 346 may also be achieved in other ways. The related descriptions of the engaging structure and its variations for connecting the sleeve portion 1502 and the rotating shaft 144 in the foregoing that are applicable here are also applicable, which will not be repeated in addition.

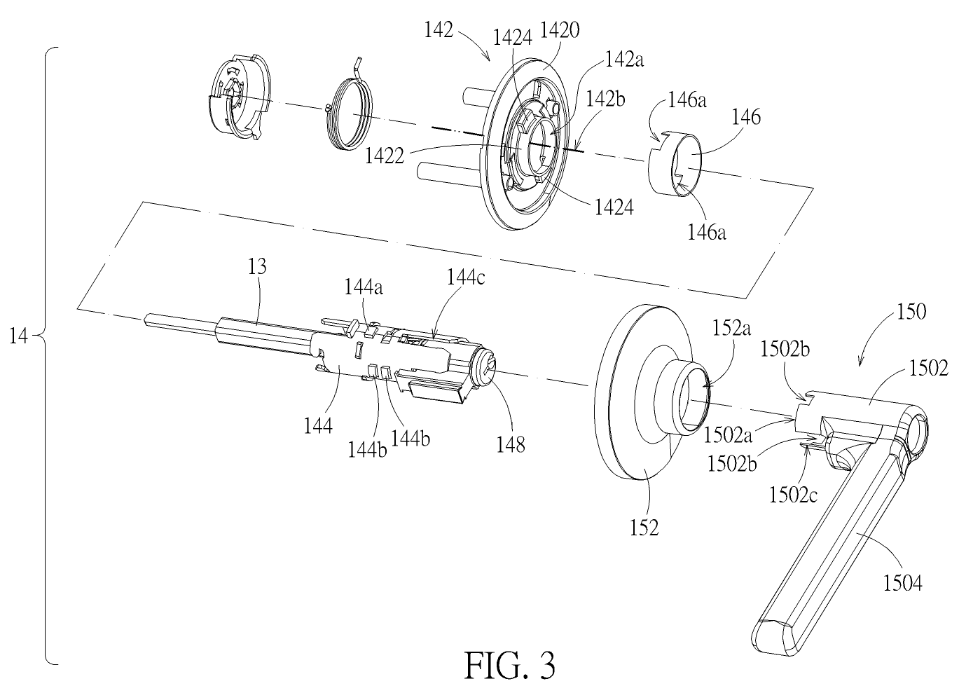

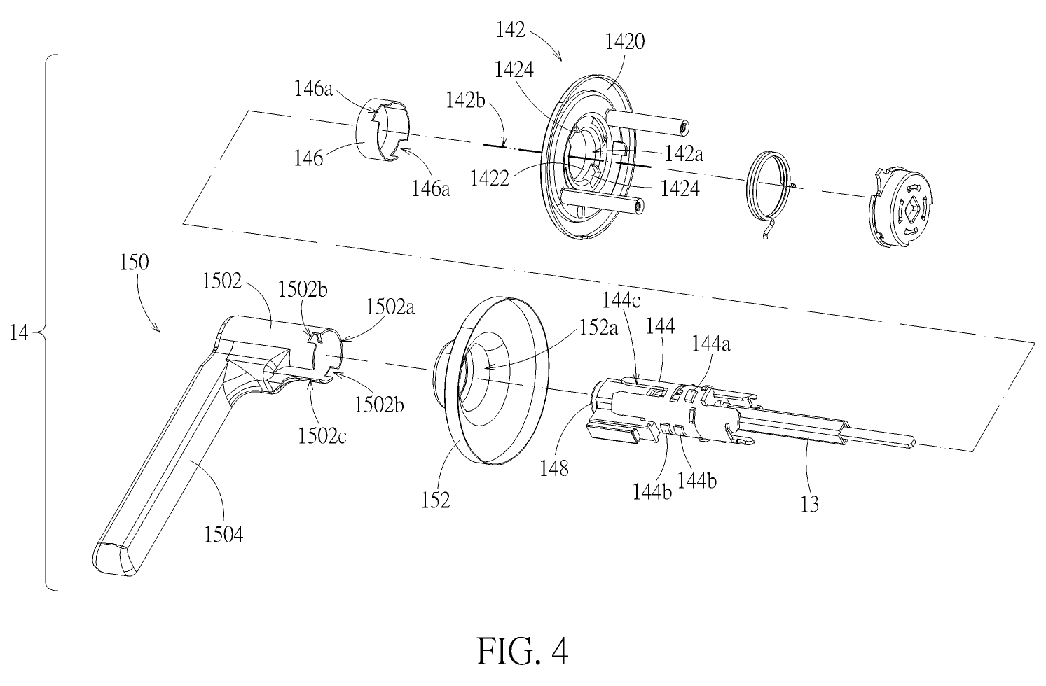

In practice, the sleeve 346 is sleeved on, for example, the rotating shaft of the inner lock body 12 of the lock 1 (referring to the rotating shaft 144 of the outer lock body 14) (therein, the rotating shaft structure modified in structure accordingly so that the rotating shaft has a protrusion that can fit in the engagement slot 351), so that the handle 350 can rotate together with the rotating shaft; on the other hand, the sleeve portion 3502 is indirectly sleeved on the rotating shaft through the sleeve 346. In addition, in the embodiment, the inner structure of the protrusion 346a of the sleeve 346 can be regarded as a groove (towards the inner side of the sleeve 346), which can also be designed to be able to engage with a protrusion on the rotating shaft (e.g., similar to the protrusion 144a of the rotating shaft 144), providing a transmission effect between the sleeve 346 and the rotating shaft. Furthermore, two ribs 346d are formed on the inner wall of the sleeve 346 and are arranged opposite to each other. The ribs 346d can also be designed to engage with open slots (e.g., the open slots 144c marked in FIGS. 3 and FIG. 4) on the rotating shaft, so as to provide a transmission effect between the sleeve 346 and the rotating shaft.

In the embodiment, the enhancement part is implemented by a sleeve 346. The sleeve 346 is combined to the inner side of a sleeve portion 3502 of the handle 350, so that the handle 350 is indirectly sleeved on the rotating shaft through the sleeve 346.In practice, the sleeve 346 may be designed to have a structural strength greater than that of the sleeve portion 3502 (e.g., by strengthening the structure or using different materials), so that the handle 350 can be stably connected to the rotating shaft through the sleeve 346. In other words, the sleeve portion 3502 is indirectly sleeved on the rotating shaft through the sleeve 346 having a greater structural strength, so the sleeve 346 can also enhance the stability of the connection between the sleeve portion 3502 and the rotating shaft. Furthermore, in the embodiment, the handle 350 and the sleeve 346 as a whole are a combined structure, which is conducive to enhancing the structural strength of a portion of the combined structure (i.e., the structure corresponding to the sleeve portion 3502), and is also conducive to taking into account the needs of manufacturability and local structural strength (e.g., the handle 350 and the sleeve 346 can be made of different materials and manufacturing methods; for another example, even if the sleeve portion 3502 and the sleeve 346 are made of the same material, the two as a whole can provide a thicker structure to enhance the local structural strength). Moreover, this combined structure can reduce the thickness of the handle 350 to reduce the weight, thereby reducing the drooping of the handle drooping. Since the sleeve 346 is arranged around the hole axis 346c, the sleeve 346 will not increase the eccentric weight and can also reduce the influence on the handle 350 drooping. In addition, in the embodiment, the sleeve portion 3502 also transmits torque directly to the rotating shaft through the engagement slot 351.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lock handle connection structure, comprising:
a mounting plate, the mounting plate having a shaft hole, the shaft hole having a hole axis;
a rotating shaft, the rotating shaft being rotatably connected to the shaft hole relative to the hole axis;
a handle, the handle comprising a sleeve portion, the sleeve portion being sleeved on the rotating shaft, so that the handle and the rotating shaft rotate together; and
an enhancement part, the enhancement part being disposed on an outer side or an inner side of the sleeve portion to keep the sleeve portion sleeved on the rotating shaft.

2. The lock handle connection structure according to claim 1, wherein the enhancement part is a ring, and the ring is fixedly disposed on the mounting plate and sleeved on the sleeve portion.

3. The lock handle connection structure according to claim 2, wherein an engagement slot is formed on one of the rotating shaft and the sleeve portion, a protrusion is formed on the other of the rotating shaft and the sleeve portion, the protrusion is fits in the engagement slot, and the protrusion and the engagement slot are located inside the ring.

4. The lock handle connection structure according to claim 3, wherein the ring completely covers the protrusion and the engagement slot.

5. The lock handle connection structure according to claim 3, further comprising a decorative cover, the decorative cover completely covering the protrusion, the engagement slot, and the ring.

6. The lock handle connection structure according to claim 3, wherein the sleeve portion has an opening, the sleeve portion is sleeved on the rotating shaft through the opening, and the engagement slot is formed on the opening.

7. The lock handle connection structure according to claim 2, wherein the mounting plate comprises a peripheral wall surrounding the shaft hole, and the ring is mounted on the peripheral wall.

8. The lock handle connection structure according to claim 7, wherein the mounting plate comprises a positioning block, the ring has a positioning slot, and the positioning block fits in the positioning slot.

9. The lock handle connection structure according to claim 2, wherein the sleeve portion has an opening and an open slot, the sleeve portion is sleeved on the rotating shaft through the opening, the open slot is formed on the opening, and the ring completely covers the opening.

10. The lock handle connection structure according to claim 1, wherein the enhancement part is a sleeve, the handle is combined with the sleeve by the sleeve portion sleeved on the sleeve, and the sleeve portion is sleeved on the rotating shaft through the sleeve.

11. The lock handle connection structure according to claim 10, wherein an engagement slot is formed on one of the sleeve portion and the sleeve, a protrusion is formed on the other of the sleeve portion and the sleeve, and the protrusion fits in the engagement slot.

12. The lock handle connection structure according to claim 11, further comprising a decorative cover, the decorative cover completely covering the protrusion and the engagement slot.

13. The lock handle connection structure according to claim 10, wherein the handle comprises a grip lever portion, the grip lever portion is connected to the sleeve portion and extends non-parallel to the hole axis, an open slot is formed on the sleeve, a plurality of protrusions are formed on one side of the sleeve portion facing the grip lever portion, the plurality of protrusions are axially arranged and protrude toward the inner side of the sleeve portion, and the plurality of protrusions fit in the open slot.

14. The lock handle connection structure according to claim 1, wherein the handle comprises a grip lever portion, and the grip lever portion is connected to the sleeve portion and extends non-parallel to the hole axis.
